(19) United States
(12) Patent Application Publication
(10) Pub. No.: US 2002/0067902 A1
(43) Pub. Date: Jun. 6, 2002

(54) Decorative optical fiber

(76) Inventor: Tsui-Tuan Wong, Hsitzu City (TW)

Correspondence Address: Bacon & Thomas, Fourth Floor, 625 Slaters Lane, Alexandria, VA, 22314, US

(21) Appl. No.: 09/732,772

(22) Filed: Dec. 5, 2000

(51) Int. Cl. G02B 6/16

(52) U.S. Cl. 385/123; 385/145; 385/147

(57) ABSTRACT

A decorative optical fiber includes a flexible thread made of an optical medium, a substantially transparent cladding encasing the flexible thread of the optical medium, and a protective covering encasing the cladding. The cladding is made of a material having a lower index of refraction than that of the optical medium, and the protective covering is substantially transparent and has a rugged outer face.

### BACKGROUND OF THE INVENTION

1. Field of the Invention

The present invention relates to a decorative optical fiber and, more particularly, to a decorative optical fiber which has an optically attractive effect for decoration.

2. Description of Related Art

Unlike optical fibers generally known for communication, a decorative optical fiber is a flexible, slim piece which gives off light at its full length and shows a pattern or sign it is configured into when a beam of light travel along it. As shown in FIGS. 3 and 4, a decorative optical fiber of a conventional type generally includes a flexible thread of an optical medium (80) of acrylic resin encased in a substantially transparent cladding (90) of fluoroplastics.

Because the fluoroplastics has a lower index of refraction that the acrylic resin, some light in the thread of the optical medium (80) will reflect but the other light will refract at an interface between the optical medium (80) and the cladding (90). Thus, the optical fiber gives off light at its full length.

The decorative optical fiber of this type is typically used only indoors, since it tends to absorb ultraviolet radiation in the sunlight, which will decompose the materials of the medium (80) and the cladding (90) and deteriorate their optical activity.

One of the solutions to the problem is to provide a covering of plastics around the cladding, for protecting the optical fiber as well as for preventing ultraviolet radiation from reaching it. However, any decorative optical fiber with the plain covering has no prevailing optical effect over one without the covering for decoration.

Therefore, it is an objective of the invention to provide a decorative optical fiber to mitigate and/or obviate the aforementioned problems.

### SUMMARY OF THE INVENTION

The object of the present invention is to provide a decorative optical fiber which has an optically attractive effect for decoration.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a decorative optical fiber in accordance with the present invention;

FIG. 2 is a cross-sectional view of the decorative optical fiber of FIG. 1;

FIG. 3 is a perspective view of a decorative optical fiber of a conventional type; and

FIG. 4 is a cross-sectional view of the decorative optical fiber of FIG. 3.

### DETAILED DESCRIPTION OF THE PREFERRED EMBODIMENT

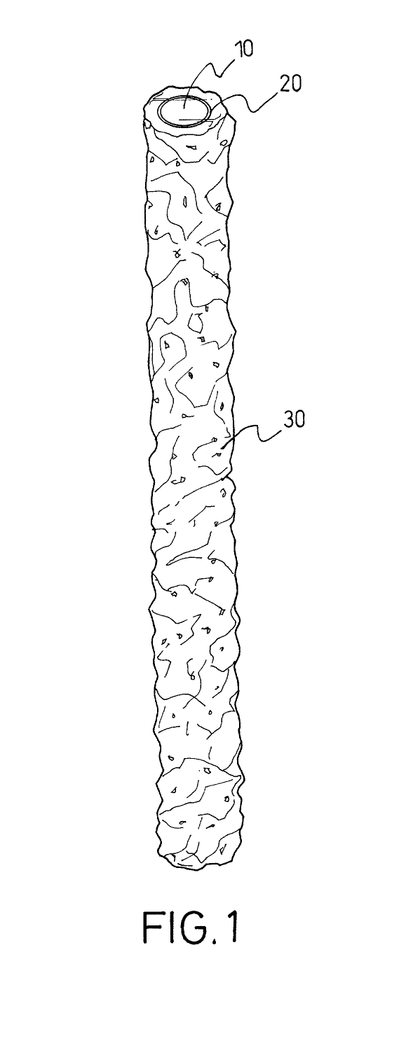

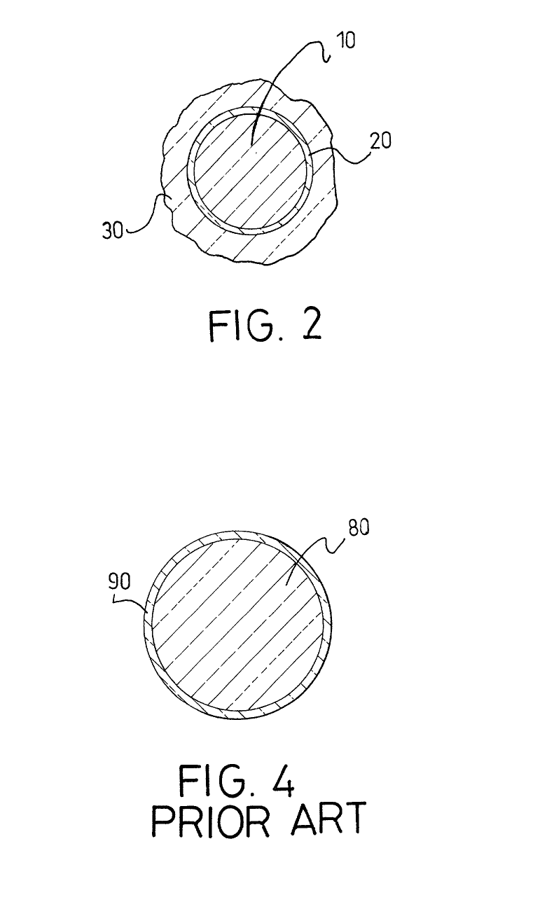

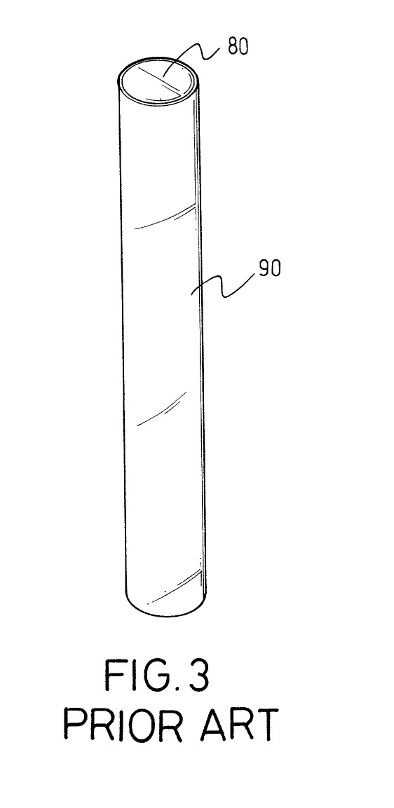

Referring to FIGS. 1 and 2, a decorative optical fiber in accordance with the present invention includes a flexible thread of an optical medium (10) encased in a substantially transparent cladding (20), with a protective covering (30) encasing the cladding (20), as shown in FIG. 2.

The substantially transparent cladding (20) is made of a material that has a lower index of refraction than the optical medium (10), such as fluoroplastics. The protective covering (30) is substantially transparent, i.e. either transparent or semitransparent, and has a rugged outer face, as shown in FIG. 1, so that the protective covering (30) glitters when light passes through the optical medium (10), thereby providing the inventive optical fiber with an optically attractive property for decoration.

According to the present invention, the protective covering (30) may be made of plastics that contains at least two plastic ingredients each having a hardness different from the other. The plastics is heated and is then applied to encase the cladding (20) by way of injection. Due to the difference of hardness between the ingredients, the rugged outer face is formed when the plastics solidifies.

In addition, the protective covering (30) preferably has a thickness between 1 and 5 mm, in order to prevent ultraviolet radiation in the sunlight from reaching the optical medium (10) and the cladding (20).

From the above description, it is noted that the invention has the following advantages:

1. optically attractive effect for decoration:

Because of its rugged outer face, the protective covering (30) glitters as crystal glass does, when light passes through the optical medium (10).

2. resistance to moisture and ultraviolet radiation:

Because of the protective covering (30) of plastics, the decorative optical fiber surely has resistance to moisture and ultraviolet radiation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A decorative optical fiber, comprising:
a flexible strip made of an optical medium (10);
a substantially transparent cladding (20) encasing said flexible thread of said optical medium (10), said cladding (20) being made of a material having a lower index of refraction than that of said optical medium (10);
a protective covering (30) encasing said cladding (20); and
wherein said protective covering (30) is substantially transparent and has a rugged outer face.

2. The decorative optical fiber as claimed in claim 1, wherein said protective covering (30) has a thickness between 1 and 5 mm.

3. The decorative optical fiber as claimed in claim 1, wherein said substantially transparent cladding (20) is made of fluoroplastics.

4. The decorative optical fiber as claimed in claim 1, wherein said protective covering (30) is made of plastics.

5. The decorative optical fiber as claimed in claim 4, wherein said plastics contains at least two types of plastic ingredients, each plastic ingredient having a hardness different from that of the other.
